(19) United States
(12) Patent Application Publication
(10) Pub. No.: US 2014/0103796 A1
(43) Pub. Date: Apr. 17, 2014

(54) LED-BASED LIGHTING ARRANGEMENTS

(71) Applicant: Intematix Corporation, Fremont, CA (US)

(72) Inventor: Michael Jansen, Palo Alto, CA (US)

(73) Assignee: Intematix Corporation, Fremont, CA (US)

(21) Appl. No.: 14/038,656

(22) Filed: Sep. 26, 2013

Related U.S. Application Data
(60) Provisional application No. 61/706,075, filed on Sep. 26, 2012.
(60) Provisional application No. 61/711,187, filed on Oct. 8, 2012.

(51) Int. Cl. F21K 99/00

(52) U.S. Cl. CPC F21K 9/54
USPC 313/498

(57) ABSTRACT

Embodiments concern various LED-based lighting arrangements, such as for use in downlights or area lights, with increased light efficacy by utilizing a light reflective component to define a light reflective mixing chamber that is substantially frusto-conical, frusto-pyramidal, hemispherical, or paraboloidal. The reflective component may be single-piece component configured to fit within a pre-existing housing and placed between the LEDs and a wavelength conversion component.

### CROSS-REFERENCE TO RELATED APPLICATIONS

The present application claims the benefit of priority to U.S. Provisional Application Ser. No. 61/706075, filed on Sep. 26, 2012, and to U.S. Provisional Application Ser. No. 61/711187, filed on Oct. 8, 2012, both of which are hereby incorporated by reference in their entireties.

### FIELD

This invention relates to LED-based lighting arrangements that utilize a remote photoluminescence wavelength conversion to generate a selected color of light. More particularly, although not exclusively, the invention concerns LED-based downlights and area lighting such as high bay lighting systems.

### BACKGROUND

White light emitting LEDs (“white LEDs”) are known and are a relatively recent innovation. It was not until LEDs emitting in the blue/ultraviolet part of the electromagnetic spectrum were developed that it became practical to develop white light sources based on LEDs. As taught, for example, in U.S. Pat. No. 5,998,925, white LEDs include one or more phosphor materials or photo-luminescent materials, which absorb a portion of the radiation emitted by the LED and re-emit light of a different color (wavelength). Typically, the LED chip or die generates blue light and the phosphor(s) absorbs a percentage of the blue light and re-emits yellow light or a combination of green and red light, green and yellow light, green and orange, or yellow and red light. The portion of the blue light generated by the LED that is not absorbed by the phosphor material combined with the light emitted by the phosphor(s) provides light which appears to the eye as being nearly white in color.

It is also known to include the phosphor material in a wavelength conversion component that is located remotely to the LED, a so called “remote phosphor” arrangement. The term “remotely” and “remote” refers to a spaced or separated relationship. Advantages of remote phosphor arrangements include a reduced likelihood of thermal degradation of the phosphor material and a more consistent color of generated light.

An example of an LED-based lighting arrangement that utilizes a remote photoluminescence wavelength conversion component will now be described with reference to FIGS. 1A and 1B which show a schematic partial cutaway plan and sectional views of the arrangement. The arrangement 100 comprises a housing 101 with a base 103 and sidewall 105. The arrangement 100 further comprises a plurality of blue light emitting LEDs (blue LEDs) 107 that are mounted to the base 103. The LEDs 107 may be configured in various arrangements.

The arrangement 100 includes a photoluminescence wavelength conversion component 109 that is positioned remotely to the LEDs 107 and is spatially separated from the LEDs. The distance of separation may be at least 1 cm. The wavelength conversion component 109 comprises a photoluminescence material, such as for example a phosphor material that absorbs a proportion of the blue light generated by the LEDs 107 and converts it to light of a different wavelength by a process of photoluminescence. A proportion of the blue light generated by the LEDs 107 is not converted to light of a different wavelength, but instead is transmitted through the wavelength conversion component 109. The final emission product of the lighting arrangement 100, which is typically white, is thus a combination of the light generated by the LEDs 107 and light generated by the wavelength conversion component 109 (e.g., light converted to a different wavelength by a process of photoluminescence).

The light mixing chamber 111 is the interior volume enclosed by the housing 101 and located between the LEDs 107 and wavelength conversion component 109. Due to the isotropic nature of photoluminescence light generation, approximately half of the light generated by the wavelength conversion component 109 can be emitted in a direction towards the LEDs and end up in the light mixing chamber 111. In addition, light that is not absorbed by the wavelength conversion component 109 can also be scattered back into the light mixing chamber 111. For this reason, the light mixing chamber 111 may have a reflective surface, so that the light in the chamber can be reflected back towards the wavelength conversion component 109 and out the device, increasing the efficiency of the lighting arrangement.

Conventional light mixing chambers are often constructed from multiple component pieces and are typically cylindrical in shape. This can present a number of problems. Being constructed from multiple pieces increases the costs of manufacturing and assembling the mixing chambers. In addition, the cylindrical shape of conventional mixing chambers creates a high loss of efficacy as many photons that are reflected into the chamber by wavelength conversion component 109 may not, due to the corners of the chamber, be reflected back towards wavelength conversion component 109 and out the arrangement.

The present invention arose in an endeavor to, at least in part, overcome the limitations and problems of LED-based lighting arrangements that utilize a remote photoluminescence wavelength conversion component.

### SUMMARY OF THE INVENTION

Embodiments of the invention concern LED-based lighting arrangements that utilize a single piece light reflective component that can be placed within a pre-existing housing to define a light reflective mixing chamber. The light reflective component may be placed between the LEDs of the lighting arrangement and a wavelength conversion component, which may comprises phosphor or quantum dots. In some embodiments, the mixing chamber defined by the light reflective component may be substantially frusto-conical (frustrum of a cone), substantially frusto-pyramidal (frustrum of a pyramid), substantially hemispherical, or substantially paraboloidal.

In some embodiments, the mixing chamber is not contained within separate housing. In other embodiments, there can be different slopes and curvatures of the sides of the mixing chamber. In further embodiments, additional secondary optics can be added, or a wavelength-selective filter can be placed within the chamber to further increase lighting arrangement efficiency. In additional embodiments, a single piece light reflective component comprises multiple compartments corresponding to multiple LEDs or LED arrays, each of which may be substantially frusto-conical, frusto-pyramidal, hemispherical, or paraboloidal.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

In order that the present invention is better understood LED-based lighting arrangements in accordance with embodiments of the invention will now be described, by way of example only, with reference to the accompanying drawings in which like reference numerals are used to denote like parts, and in which:

FIGS. 1A and 1B respectively illustrate cross-sectional and top-down views of an example LED-based lighting arrangement;

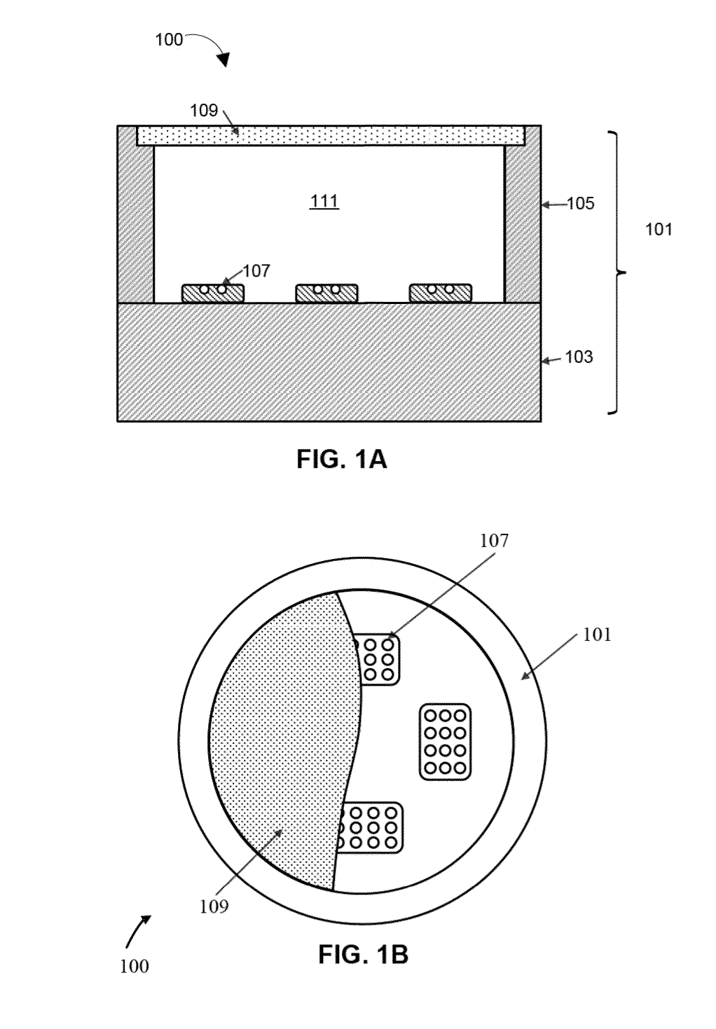

FIGS. 2A and 2B respectively illustrate cross-sectional and top-down views of an LED-based lighting arrangement utilizing a single-piece light reflective component according to some embodiments;

FIG. 2C illustrates a cross-sectional view of an LED-based lighting arrangement with a conical light mixing chamber where the walls of the housing are flush with single-piece light reflective component;

FIG. 3 illustrates an exploded perspective view of an LED-based lighting arrangement utilizing a single-piece light reflective component according to some embodiments;

FIG. 4 illustrates a cross-sectional view of an LED-based lighting arrangement with a wavelength-selective filter according to some embodiments;

FIG. 5 illustrates a cross-sectional view of an LED-based lighting arrangement with secondary optics according to some embodiments;

FIG. 6A-6B illustrates embodiments with mixing chambers with steeper or flatter sides;

FIG. 7 illustrates an embodiment of a light reflective component defining a mixing chamber with curved walls;

FIG. 8 illustrates an embodiment with a curved or domed wavelength conversion component;

FIG. 9A illustrates a cross-sectional view of an embodiment using a light reflective component comprising a plurality of conical compartments;

FIG. 9B illustrates a top-down cross-sectional view of an embodiment using a light reflective component comprising a plurality of conical compartments;

FIG. 9C illustrates an exploded view of an embodiment using a light reflective component comprising a plurality of conical compartments;

FIG. 10A illustrates a variety of downlights in accordance with some embodiments; and

FIG. 10B illustrates an exploded view of a downlight in accordance with some embodiments.

### DETAILED DESCRIPTION

Various embodiments are described hereinafter with reference to the figures. It should be noted that the figures are not necessarily drawn to scale. It should also be further noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments” in various places throughout this specification are not necessarily referring to the same embodiment or embodiments.

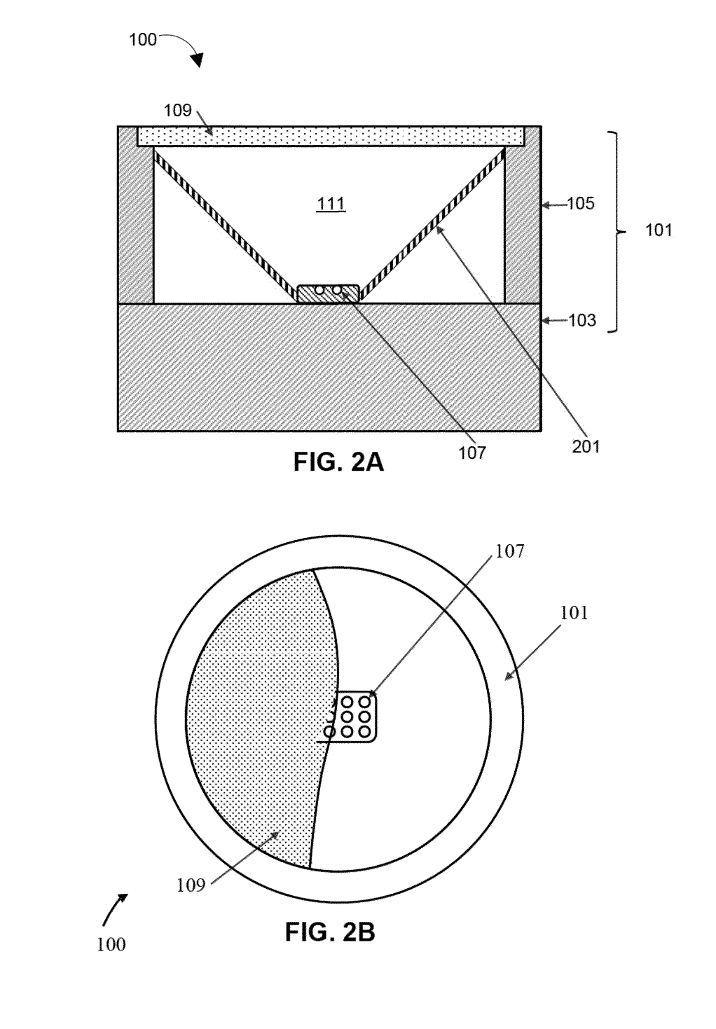

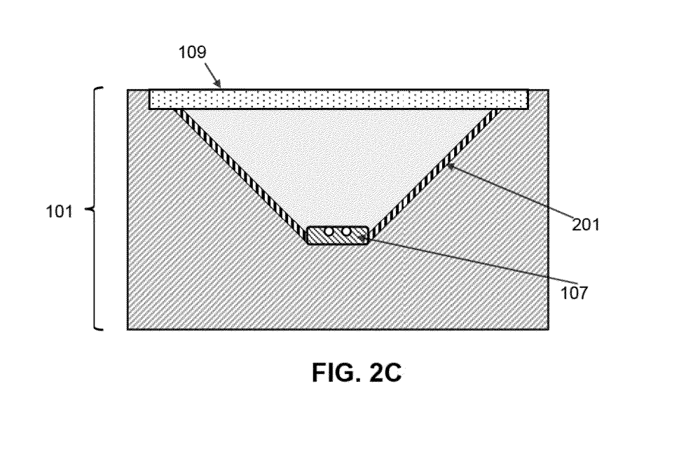

FIGS. 2A and 2B illustrate an LED-based lighting arrangement, for example downlight, 100 according to some embodiments. The downlight 100 comprises a housing 101 with a thermally conductive base 103 and sidewall 105. The downlight 100 further comprises a plurality of blue light emitting LEDs (blue LEDs) 107 that are mounted to the base 103. The thermally conductive base 103 provides a heat sink to dissipate the heat generated by LEDs 107. The downlight 100 includes a photoluminescence wavelength conversion component 109 that is positioned remotely to the LEDs 107, and a light mixing chamber 111.

LEDs 107 may be individual LEDs, or arranged as part of a chip-on-board (COB) array or an LED array. In some embodiments, the LEDs may be mounted in thermal communication with an MCPCB (metal core printed circuit board). As one example, the LEDs 107 can comprise chips on ceramic devices in which each device comprises a ceramic packaged array of twelve 0.4 W GaN-based (gallium nitride-based) blue LED chips that are configured as a rectangular array 3 rows by 4 columns, wherein the LEDs are operable to generate blue light having a peak wavelength in a wavelength range 400 nm to 480 nm (typically 450 nm to 470 nm). An MCPCB may comprise a layered structure composed of a metal core base (e.g., aluminum), a thermally conductive/electrically insulating dielectric layer and a copper circuit layer for electrically connecting electrical components in a desired circuit configuration. The metal core base of the MCPCB may be mounted in thermal communication with the base 103 with the aid of a thermally conductive compound, such as for example an adhesive containing a standard heat sink compound containing beryllium oxide or aluminum nitride.

Because the LEDs are non-reflective, and will absorb a portion of the light in the light mixing chamber, they may be placed together in the center of the device, and are tightly packed in order to decrease the surface area of the LEDs and thus increase the efficiency of the downlight. In some embodiments, the LEDs 107 are mounted on an MCPCB comprising light reflective material to facilitate the redirection of light reflected back into the light mixing chamber 111 towards the wavelength conversion component 109. Of course, a single LED 107 may instead be utilized if desired.

The wavelength conversion component 109 includes a photoluminescence material that may be coated on a surface of, or distributed throughout the thickness of, an optical component made of glass, plastic, silicone, or other suitable material. In some embodiments, the photoluminescence materials comprise phosphor materials. For the purposes of illustration only, the following description is made with reference to photoluminescence materials embodied specifically as phosphor materials. However, the invention is applicable to any type of photoluminescence material, such as either phosphor materials or quantum dots.

The one or more phosphor materials can include an inorganic or organic phosphor such as for example silicate-based phosphors, aluminate-based phosphors, aluminate-silicate phosphors, nitride phosphors, sulfate phosphor, oxy-nitrides and oxy-sulfate phosphors or garnet materials (YAG). Examples of silicate-based phosphors are disclosed in U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors” and U.S. Pat. No. 7,311,858 B2 “Silicate-based yellow-green phosphors”. Examples of aluminate materials are disclosed in U.S. Pat. No. 7,541,728 B2 “Novel aluminate-based green phosphors” and U.S. Pat. No. 7,390,437 B2 “Aluminate-based blue phosphors”. An example of an aluminate-silicate phosphor is disclosed in U.S. Pat. No. 7,648,650 B2 “Aluminum-silicate orange-red phosphor”. Examples of nitride-based red or green phosphor materials include those disclosed in United States patent applications: US 2012/0043503 A1 “Europium-Activated, Beta-SiAlON Based Green Phosphors”, US2009/0283721 A1 “Nitride-based red phosphors”, US2013-0234589 “Red-Emitting Nitride-Based Phosphors”, US 2013/0168605 A1 “Nitride Phosphors with Interstitial Cations for Charge Balance” and U.S. Pat. No. 8,274,209 B2 “Nitride-based red-emitting in RGB (red-green-blue) lighting systems”. The entire content of each of the aforementioned applications and patents are incorporated herein by way of reference thereto. It will be appreciated that the phosphor material is not limited to the examples described and can include any phosphor material as known in the art.

A quantum dot is a portion of matter (e.g. semiconductor) whose excitons are confined in all three spatial dimensions that may be excited by radiation energy to emit light of a particular wavelength or range of wavelengths. Quantum dots can comprise different materials, for example cadmium selenide (CdSe). The color of light generated by a quantum dot is enabled by the quantum confinement effect associated with the nano-crystal structure of the quantum dots. The energy level of each quantum dot relates directly to the size of the quantum dot. For example, the larger quantum dots, such as red quantum dots, can absorb and emit photons having a relatively lower energy (i.e. a relatively longer wavelength). On the other hand, orange quantum dots, which are smaller in size can absorb and emit photons of a relatively higher energy (shorter wavelength). Additionally, daylight panels are envisioned that use cadmium-free quantum dots and rare earth (RE) doped oxide colloidal phosphor nano-particles, in order to avoid the toxicity of the cadmium in the quantum dots.

The material of the quantum dots can comprise core/shell nano-crystals containing different materials in an onion-like structure. For example, the above described exemplary materials can be used as the core materials for the core/shell nano-crystals. The optical properties of the core nano-crystals in one material can be altered by growing an epitaxial-type shell of another material. Depending on the requirements, the core/shell nano-crystals can have a single shell or multiple shells. The shell materials can be chosen based on the band gap engineering. For example, the shell materials can have a band gap larger than the core materials so that the shell of the nano-crystals can separate the surface of the optically active core from its surrounding medium. In the case of the cadmium-based quantum dots, e.g. CdSe quantum dots, the core/shell quantum dots can be synthesized using the formula of CdSe/ZnS, CdSe/CdS, CdSe/ZnSe, CdSe/CdS/ZnS, or CdSe/ZnSe/ZnS. Similarly, for CuInS₂ quantum dots, the core/shell nano-crystals can be synthesized using the formula of CuInS₂/ZnS, CuInS₂/CdS, CuInS₂/CuGaS₂, CuInS₂/CuGaS₂/ZnS and so on.

Due to the isotropic nature of photoluminescence light generation, approximately half of the light generated by the phosphor material of the wavelength conversion component 109 can be emitted in a direction towards the LEDs and will end up in the light mixing chamber 111. It is believed that on average as little as 1 in a 10,000 interactions of a photon with a phosphor material particle results in absorption and generation of photoluminescence light. The majority, about 99.99%, of interactions of photons with a phosphor particle result in scattering of the photon. Due to the isotropic nature of the scattering process on average half the scattered photons will be in a direction back towards the light emitters. As a result up to half of the light generated by the LEDs that is not absorbed by the phosphor material can also end up back in the light mixing chamber 111.

Unlike a conventional light mixing chamber, where the walls of the mixing chamber 111 would be defined by base 103 and sidewall 105, the embodiment in FIGS. 2A and 2B shows a mixing chamber 111 defined by a one-piece light reflective component (hereinafter termed a “reflector”) 201 inserted into the cavity defined by base 103 and sidewall 105. In some embodiments, the interior of the cavity defined by base 103 and sidewalls 105 does not contain an optical medium allowing the reflector 201 to be readily inserted into the chamber.

The reflector 201 is a single piece component, making it less expensive to manufacture and assemble. To maximize light emission from the downlight and to improve the overall efficiency of the downlight, the interior surfaces of the reflector are light reflective and/or highly diffusive, so as to redirect light in the interior volume towards the wavelength conversion component and out of the downlight. In some embodiments, the light reflective surfaces can comprise a highly light reflective sheet material, such as for example WhiteOptics™ “White 97” (A high-density polyethylene fiber-based composite film) from A.L.P. Lighting Components, Inc. of Niles, Ill., USA.

The shape of the light mixing chamber 111 created by the reflector 201 also helps to reflect the light from LEDs 107 towards the wavelength conversion component 109. In the embodiment illustrated in FIGS. 2A and 2B, the light mixing chamber 111 is substantially conical or frusto-conical (frustrum of a cone). A conical or frusto-conical mixing chamber facilitates higher light efficiency, because unlike a cylindrical chamber, it does not contain vertical walls and corners that can reflect the light away from wavelength conversion component 109.

For the purposes of this specification, the side of the conical reflector 201 interfacing with the LED or LED array 107 may hereinafter be referred to as the bottom surface or plane of the conical reflector, while the side interfacing with the wavelength conversion component 109 and/or sidewalls 105 may be referred to as the top surface or plane. In some embodiments, the bottom surface of the reflector 201 directly interfaces with or touches the LED array 107. This may be done to minimize the exposed surface area of base 103. The top surface of reflector 201 may be configured to interface with the sidewalls 105 of housing 101, and/or the wavelength conversion component 109.

In the illustrated embodiment, the mixing chamber 111 defined by the reflector 201 is substantially frusto-conical in form. In other embodiments, the mixing chamber may be frusto-pyramidal in form. Other generally frusto-conical or frusto-pyramidal configurations may also be used. For example, the opening at the bottom and top surfaces of the reflector 201 may be configured to correspond with the shape or form of the LED array 107 and the shape defined by sidewalls 105, respectively. If the LED array 107 is square in shape while the chamber defined by the sidewalls 105 is circular, the reflector 201 may have a square bottom surface (opening) and a circular top surface (opening). For the purposes of the present specification, these shape configurations may be hereinafter referred to collectively as “conical.”

FIG. 2C illustrates an embodiment where the reflector 201 is flush with the sidewalls 105. This can be advantageous in embodiments where the sidewalls 105 are constructed from a material where it is expensive or impractical to treat with a light reflective surface. In these cases, a separate one-piece reflector 201 with a surface of light reflective material may be inserted within the mixing chamber 111 to rest upon sidewalls 105, increasing the efficacy of the lighting arrangement. In some embodiments, the one-piece reflector 201 can itself act as housing for the LEDs 107, eliminating the need for a separate sidewall structure 105.

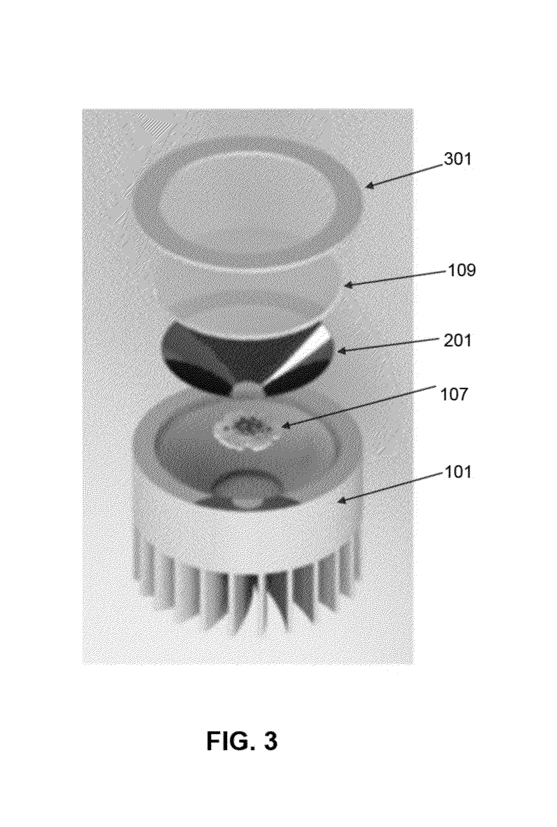

FIG. 3 illustrates an exploded perspective view of an LED-based lighting arrangement, (e.g., a downlight) utilizing a conical reflector 201. As illustrated in FIG. 3, the downlight comprises a housing 101, LED array 107, reflector 201, wavelength conversion component 109, and annular cover ring 301 which is used to fix the wavelength conversion component 109 over the opening of housing 101. The inside of the reflector 201 is composed of a highly-reflective, highly-diffusive material. As can be seen in FIG. 3, the conical reflector 201 has a slope so that the area of the bottom plane is small compared the area of the top plane. For example, in some embodiments, the top plane of the reflector 201 may be configured to have ten times the area as the bottom plane. LEDs 107 are positioned at the bottom plane of reflector 201. Because LEDs 107 are non-reflective, by placing them within a small area, the amount of light that is absorbed instead of reflected in the light mixing chamber 111 can be reduced, increasing the efficacy of the device.

Thus, compared to a conventional light mixing chamber, use of the reflector 201 allows for a higher light conversion efficiency by lowering light loss. In addition, the reflector 201 is a single piece that can be easily manufactured (e.g., through vacuum-forming), and may be configured to be easily placed into existing chambers. Because the reflector 201 covers the walls of the existing chamber, the base and sidewalls of the existing chamber do not need to be separately treated or coated with light-reflective materials.

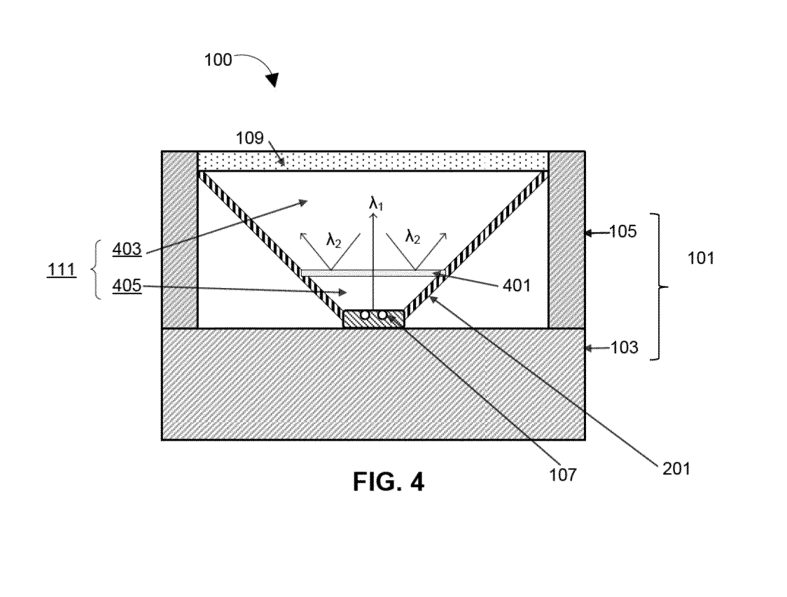

FIG. 4 illustrates an embodiment where a wavelength-selective filter 401 is placed within the light mixing chamber 111 between the LEDs 107 and the wavelength conversion component 109, dividing the light mixing chamber 111 into upper chamber 403 and lower chamber 405. In some embodiments, reflector 201 may contain an indentation or other structural feature for inserting filter 401.

In some embodiments, filter 401 may be a dielectric filter, a dichroic filter, or a bandpass filter. The filter 401 may be used to increase the efficiency of the arrangement by reducing the light in the light mixing chamber 111 that can be potentially absorbed by non-reflective elements within mixing chamber 111, such as the LEDs 107. The filter 401 is transmissive to wavelengths (λ₁) of light corresponding to those generated by the LEDs (e.g., blue), permitting the LED light to pass through from lower chamber 405 to upper chamber 403. However, filter 401 is reflective to light of longer wavelengths (λ₂), including the light generated by the wavelength conversion component 109. This light will be reflected by filter 401, and thus will not be able to enter lower chamber 405 where it may be potentially absorbed by non-reflective surfaces such as LEDs 107. Instead, the light will remain in upper chamber 403 until it is redirected through the wavelength conversion component 109 and out of the arrangement.

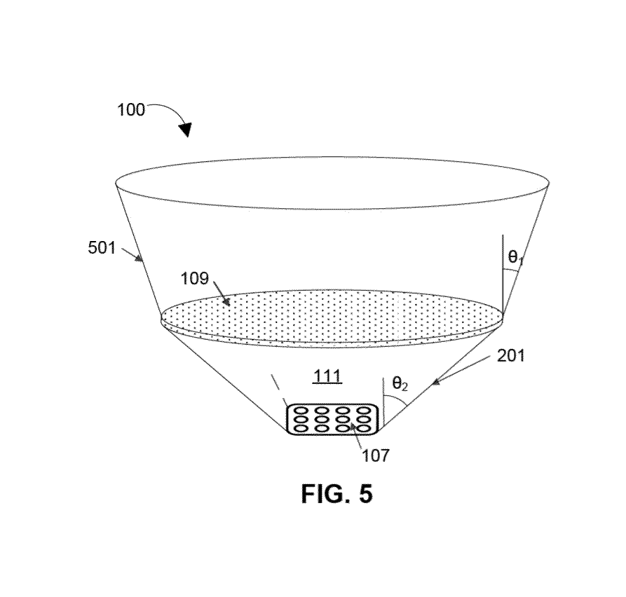

FIG. 5 illustrates an embodiment containing additional secondary optics 501 outside the light mixing chamber. In some embodiments, the secondary optics 501 can be constructed from a different material as the conical reflector 201. In some embodiments, the secondary optics 501 are part of the same single piece as the conical reflector 201. The secondary optics 501 can have an angle θ₂ that is different than the angle θ₁ of the conical reflector 201. The secondary optics 501 can perform a variety of functions, such as narrowing the field of light that is emitted by the arrangement if the angle θ₂ is less than that of θ₁.

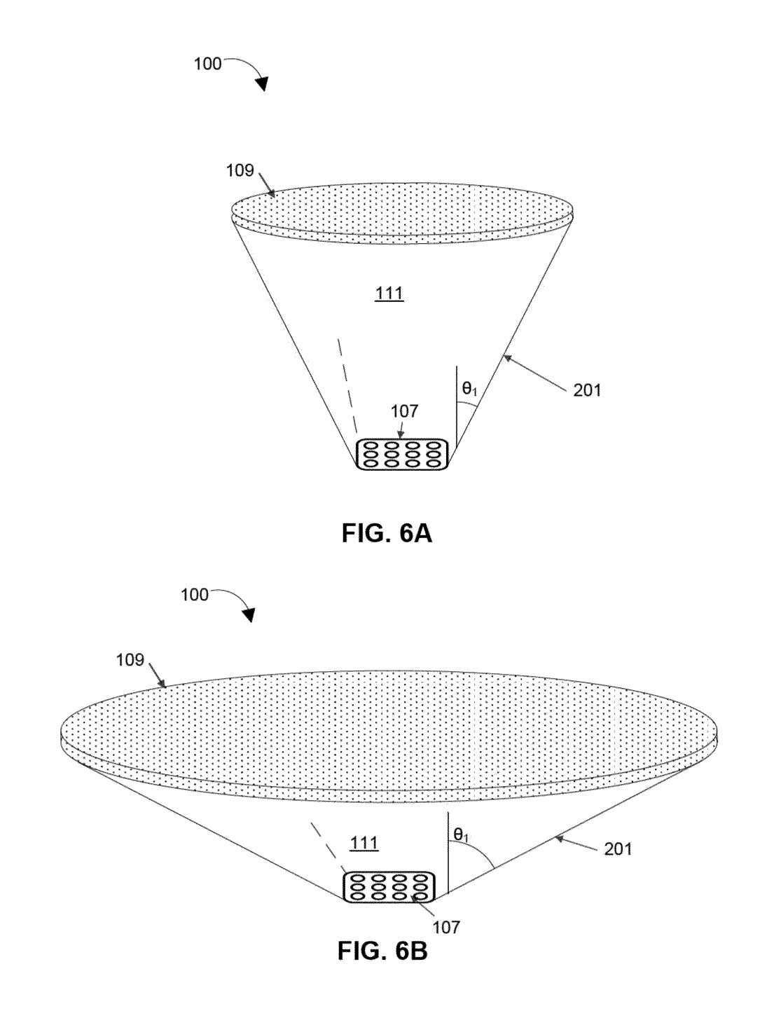

The walls of conical reflector 201 can have different slopes and angles θ₁ depending on the particular application. FIGS. 6A and 6B illustrate embodiments where the mixing chamber 111 has a steeper or flatter slope. FIG. 6A illustrates an embodiment having a steeper slope (smaller θ₁), while FIG. 6B illustrates an embodiment with a flatter slope (larger θ₁). Generally, a mixing chamber with a flatter slope will have higher efficiency due to more of the light emitted from the LEDs 107 and reflected from wavelength conversion component 109 being redirected back towards wavelength conversion component 109 and out the arrangement. However, a mixing chamber with a flatter slope will also tend to have a broader field of emitted light and take up more surface area than a conical mixing chamber with a steeper slope, requiring the use of more phosphor materials. Also, when utilizing a mixing chamber with a flatter slope, a minimum distance between LEDs 107 and wavelength conversion component 109 should be maintained in order to reduce the likelihood of thermal degradation of the wavelength conversion component 109 and to maintain a consistent color of generated light that does not contain visible point sources. In some embodiments, the minimum distance may be 5 mm-10 mm.

With reference to the orientation of FIG. 6B on the page, an example of a ratio of the area of the upper opening of the conical reflector 201 to the area of the lower opening of the conical reflector 201 may be substantially 9:1 or above. As that ratio increases, the efficiency of the conical reflector 201 increases as well, as long as the LED or LEDs 107 are not positioned so close to the wavelength conversion component 109 that they appear as “hot” spots to an observer or transmit so much heat to the wavelength conversion component 109 that would result in color drift of the wavelength conversion component 109.

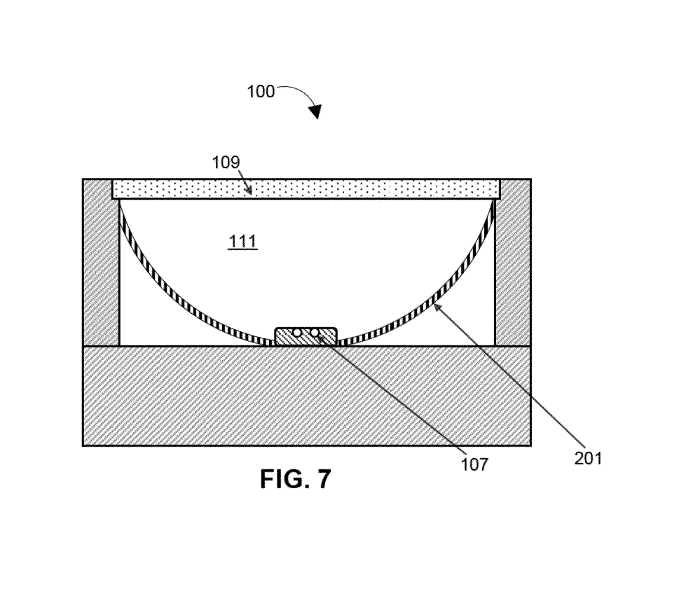

FIG. 7 illustrates an embodiment where the walls of one-piece reflector 201 are substantially hemispherical. The slope and curvature of the reflector can be adjusted to alter the way light is reflected in the light mixing chamber, potentially increasing efficiency or altering the field in which the light is projected. In some embodiments, the reflector 201 may be generally hemispherical, ellipsoidal or paraboloidal in form.

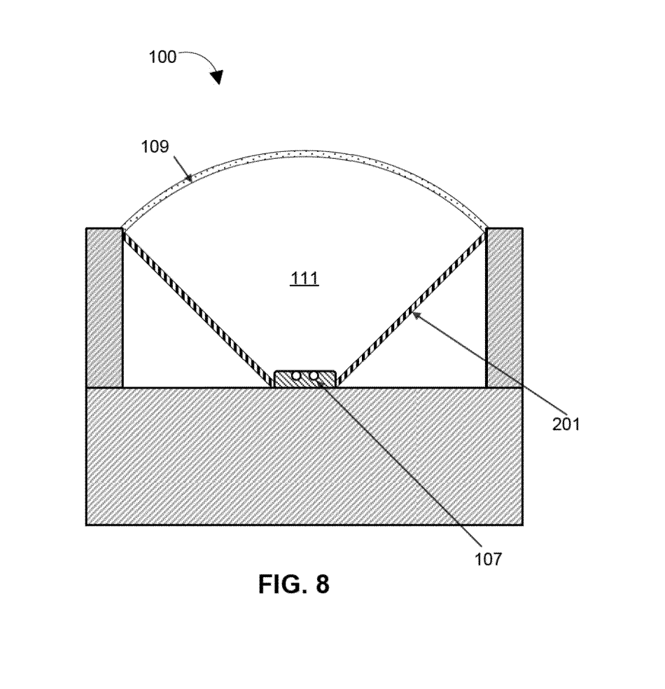

FIG. 8 illustrates an embodiment where the wavelength conversion component 109, instead of being flat (planar) as shown in previous figures, has a curved or dome shape. By shaping the wavelength conversion component 109 as a dome, the consistency of the generated light can be improved. The domed shape of wavelength conversion component 109 allows for a flatter mixing chamber while maintaining at least the minimum required distance between wavelength conversion component 109 and LEDs 107 to prevent thermal degradation of wavelength conversion component 109. In addition, some of the light reflected from the wavelength conversion component 109 can be reflected into the opposite side of wavelength conversion component 109, instead of the walls of light mixing chamber 111, potentially increasing efficiency of the arrangement.

In addition to LED-based lighting arrangements having an LED or an LED array in the center, the invention can be adapted for arrangements containing multiple LEDs or LED arrays in different locations in the housing by using a single-piece reflector that comprises a plurality of substantially compartments. This can be desirable because it potentially allows for the device to generate a greater amount of light by being able to have a greater number of LEDs or LED arrays within the device. Such arrangements find particular utility in area lighting applications such as high bay lighting systems.

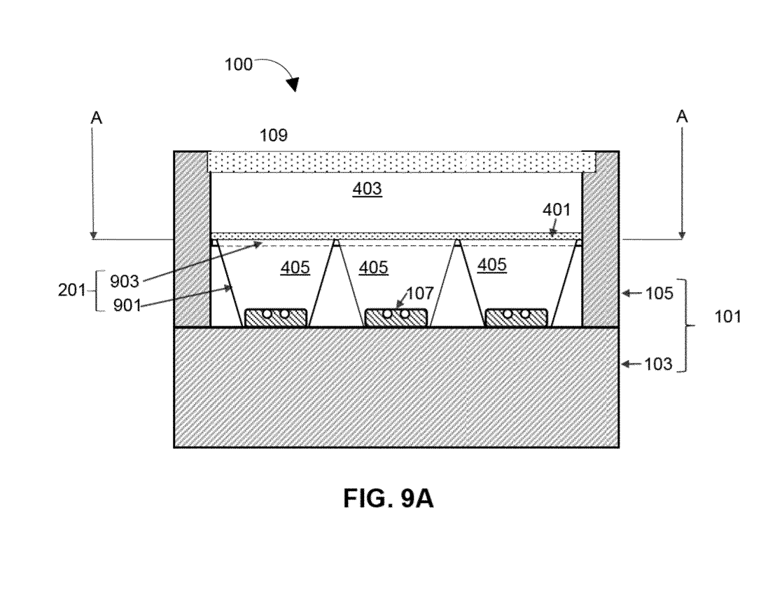

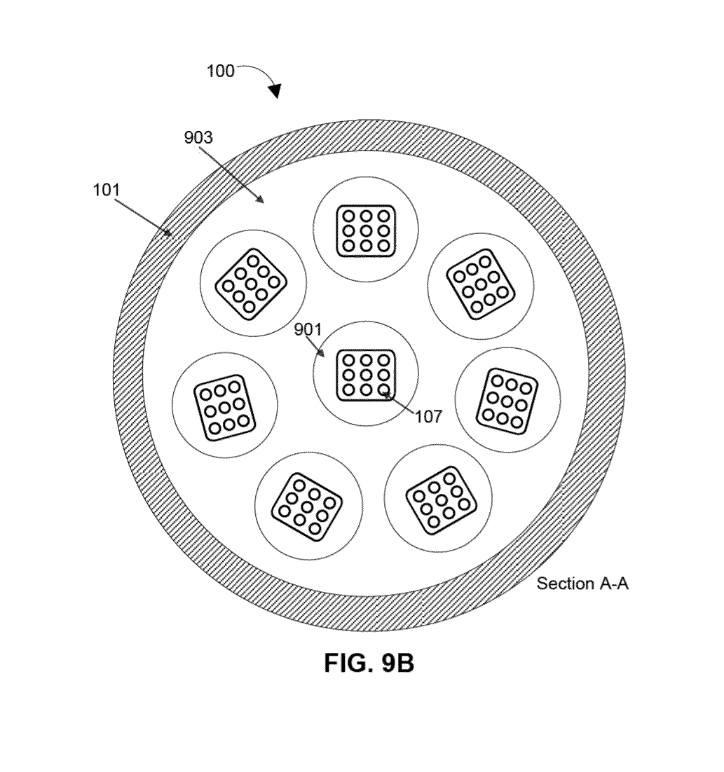

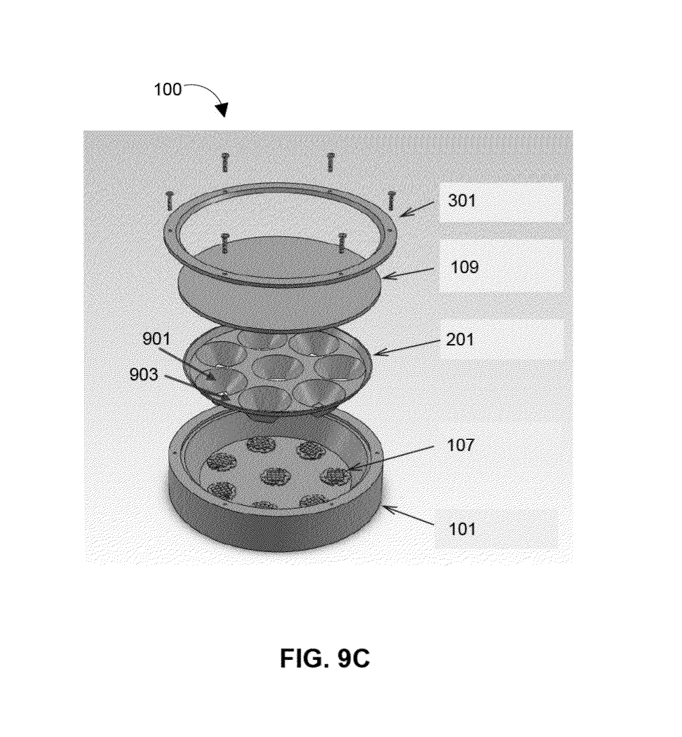

FIG. 9A, 9B and 9C illustrate high bay lighting arrangements 100 containing a plurality of LEDs or LED arrays spread out over the base of the housing. The lighting arrangements 100 comprises a housing 101 with a base 103 and sidewall 105, a plurality of LEDs 107 mounted on base 103, a wavelength conversion component 109 attached to housing 101 through a cover ring 301 using a plurality of fixtures such as bolts or screws, a single-piece conical reflector 201 defining a light mixing chamber 111. In this embodiment, the LEDs or LED arrays 107, instead of being placed only in the center of the device 100, may be placed in multiple locations and in various arrangements on base 103. The reflector 201 comprises a plurality of separate substantially conical light reflective compartments 901 connected by a top disk 903, wherein each compartment 901 is centered on a respective LED or LED array 107. The bottom opening of each conical compartment 901 may correspond with the shape of the LED or LED array 107. For example, in the illustrated embodiment, the bottom opening of each conical compartment 901 is square to correspond to the square shape of its respective LED array 107, while the top opening of each conical compartment may be circular. The top and bottom openings of the conical compartments may be different shapes in other embodiments. The inside walls of each conical compartment 901 are light reflective to improve the mixing chamber efficiency. The top of disk 903 may also be light reflective. In some embodiments, the sides of disk 903 will be flush with sidewall 105 thereby preventing light from entering the space between conical compartments 901 and base 103. FIG. 9A illustrates a cross sectional view of the embodiment. FIG. 9B illustrates a top-down cross-sectional view of the embodiment. FIG. 9C illustrates an exploded view of the embodiment.

The conical compartments 901 have a height that is less than the distance between base 103 and wavelength conversion component 109. Because conical compartments 901 may direct light generated by LEDs 107 to a narrower field, the distance between the top of conical compartments 901 and the wavelength conversion component 109 should be large enough to maintain a consistent color of generated light that does not contain visible point sources. An example of a percentage of the height of the conical compartments 901 compared to the distance between LEDs 107 and wavelength conversion component 109 may be substantially 50-70%.

In the embodiment illustrated in FIG. 9A, 9B, and 9C, a wavelength-selective filter 401 may be placed on top of reflector 201, separating mixing chamber 111 into an upper chamber 403 and a plurality of lower chambers 405 defined by conical compartments 901. Because wavelength-selective filter 401 permits the blue light (λ₁) emitted from LEDs to pass from lower chambers 405 to upper chamber 403, but reflects light generated by the wavelength conversion component 109 (λ₂), the light arrangement efficiency is improved by preventing light generated by wavelength conversion component 109 entering the lower chambers 405 where it may be potentially absorbed by non-reflective surfaces such as LEDs 107. Instead, the light emitted by the wavelength conversion component 109 will remain in upper chamber 403 until it is redirected through the wavelength conversion component 109 and out of the arrangement. This improves the efficiency of the arrangement and helps to eliminate the appearance of visible point sources, “hot” spots, within the arrangement.

The above applications of LED-based lighting arrangements describe only a few embodiments with which the claimed invention may be applied. It is important to note that the claimed invention may be applied to other types of lighting arrangements, including but not limited to, wall lamps, pendant lamps, chandeliers, recessed lights, track lights, accent lights, stage lighting, movie lighting, street lights, flood lights, beacon lights, security lights, traffic lights, headlamps, taillights, signs, etc.

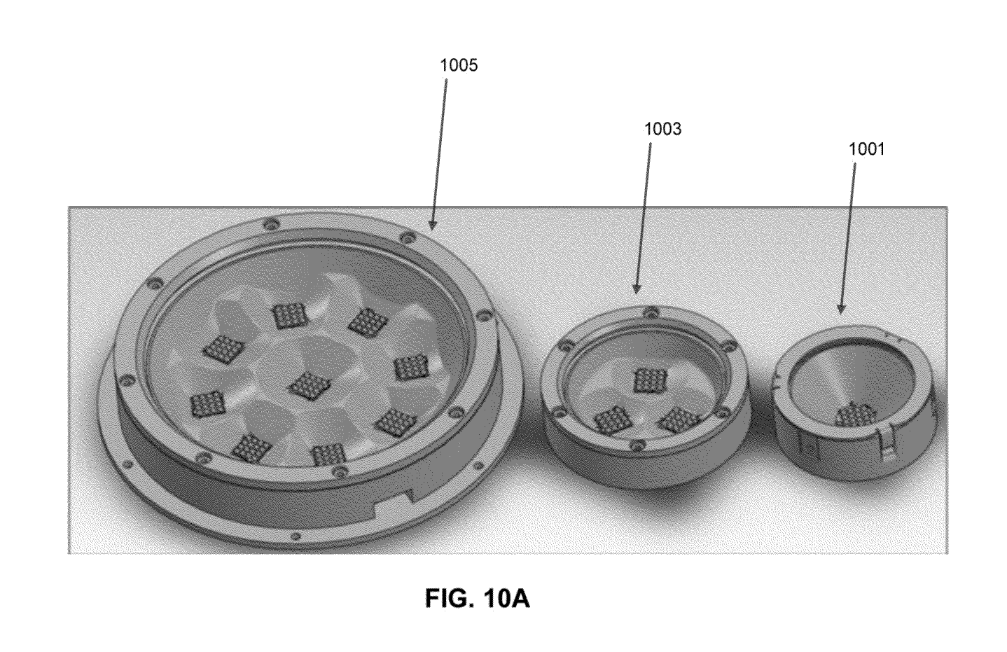

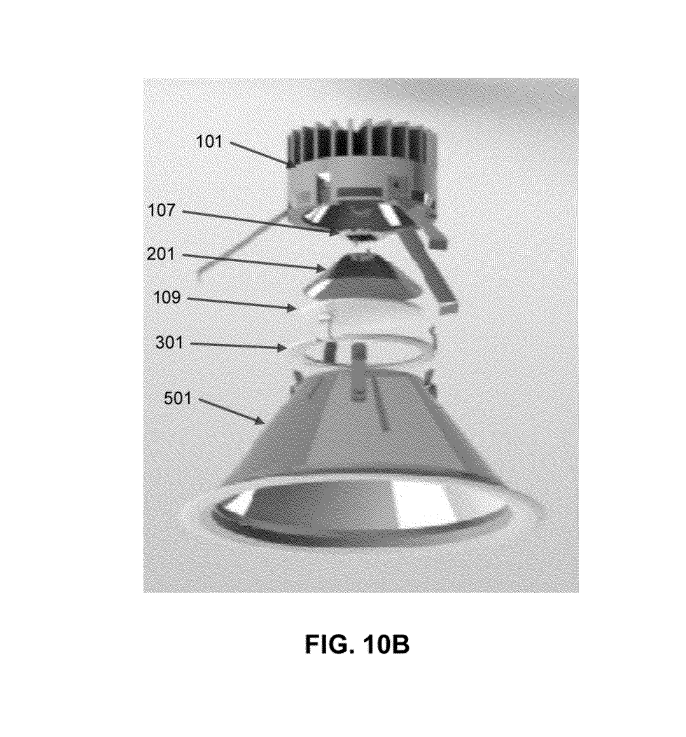

For example, FIG. 10A illustrates three lights that may be used as downlights or high bay lights, in accordance with some embodiments. In the illustrated embodiment, downlight 1001 has a reflector configured for a single LED array, and is configured to emit approximately 1000 to 3000 lumens of light. Downlight 1003 has a reflector configured for three LED arrays, and is configured to emit approximately 3000 to 6000 lumens. High bay light 1005 has a reflector configured for eight LED arrays, and is configured to emit 20,000 to 22,000 lumens. FIG. 10B illustrates an exploded view of a downlight assembly in accordance with some embodiments. The downlight comprises a housing 101, LED array 107, reflector 201, wavelength conversion component 109, and cover ring 301. In addition, the downlight has a secondary reflector or hood 501 used to focus or direct the light emitted by the downlight downwards.

Therefore, what has been described are LED-based lighting arrangements with improved efficiency through the use of a conical light mixing chamber. In some embodiments, the conical light mixing chamber is achieved by inserting a one-piece conical reflector into a cylindrical housing, while in other embodiments, the one-piece conical reflector can itself function as the housing. Different embodiments can vary the slope of chamber wall or utilize a conical light mixing chamber with curved walls or a light mixing chamber with multiple conical compartments.

In the foregoing description, the invention has been described with reference to specific embodiments thereof. It will, however, be evident that various modifications and changes may be made thereto without departing from the broader spirit and scope of the invention. The specification and drawings are accordingly, to be regarded in an illustrative rather than restrictive sense.

1. A lighting arrangement, comprising:
at least one LED array configured to emit light of a first wavelength range;
a photoluminescence wavelength conversion component, wherein the wavelength conversion component is configured to absorb light emitted from the at least one LED array of the first wavelength range and to emit light of a second wavelength range;
a reflector component having a first open end configured to interface with the at least one LED array and a second open end configured to interface with the wavelength conversion component, wherein an inside volume of the reflector component defines a light mixing chamber between the at least one LED array and wavelength conversion component.

2. The lighting arrangement of claim 1, wherein the first open end of the reflector component is smaller than the second open end of the reflector.

3. The lighting arrangement of claim 2, wherein the reflector component is substantially conical in form.

4. The lighting arrangement of claim 2, wherein the reflector component has a hemispherical surface.

5. The lighting arrangement of claim 1, further comprising a housing with a bottom surface and an open end opposite the bottom surface, wherein the at least one LED array is attached to the bottom surface of the housing, the wavelength conversion component interfaces with the open end of the housing, and the reflector component is configured to fit within the housing between the at least one LED array and wavelength conversion component.

6. The lighting arrangement of claim 1, further comprising a wavelength-selective filter located between the at least one LED array and the wavelength conversion component, wherein the wavelength-selective filter is substantially transmissive to light of the first wavelength range and substantially reflective to light of the second wavelength range.

7. The lighting arrangement of claim 6, wherein the wavelength-selective filter comprises a dielectric filter, a dichroic filter or a bandpass filter.

8. The lighting arrangement of claim 1, wherein the wavelength conversion component comprises one or more phosphors.

9. A lighting arrangement, comprising:
a housing comprising a bottom surface, one or more side surfaces, and an open end opposite the bottom surface;
at least one LED array located on the bottom surface of the housing, comprising one or more LEDs are configured to emit light of a first wavelength range;
a wavelength conversion component configured to interface with the open end of the housing, wherein the wavelength conversion component is configured to absorb light emitted from the at least one LED array of the first wavelength range and to emit light of a second wavelength range;
an light reflective insert configured to fit within the housing, having a first open end configured to interface with the at least one LED array and a second open end configured to face the wavelength conversion component, wherein the inside volume of the insert defines a light mixing chamber between the at least one LED array and wavelength conversion component.

10. The lighting arrangement of claim 9, comprising a plurality of LED arrays on the bottom surface of the housing, and wherein the insert comprises a plurality of first open ends configured to interface with a respective one of the plurality of LED arrays.

11. The lighting arrangement of claim 10, further comprising a wavelength-selective filter interfacing with the open end of the insert facing the wavelength conversion component, wherein the wavelength-selective filter is substantially transmissive to light of the first wavelength range and substantially reflective to light of the second wavelength range.

12. The lighting arrangement of claim 11, wherein the wavelength-selective filter comprises a dielectric filter, a dichroic filter or a bandpass filter.

13. The lighting arrangement of claim 10, wherein the insert comprises a plurality of substantially conical chambers, each chamber corresponding to a respective one of the plurality of LED arrays.

14. The lighting arrangement of claim 10, wherein a shape of the plurality of first open ends of the insert corresponding with the plurality of LED arrays is configured to match a shape of the plurality of LED arrays.

15. The lighting arrangement of claim 9, wherein a height of the insert is approximately between 50 and 70% of a height of the housing.

16. The lighting arrangement of claim 9, wherein the housing is substantially cylindrical.

17. The lighting arrangement of claim 9, wherein the at least one LED array is located at the center of the bottom surface of the housing.

18. The lighting arrangement of claim 9, wherein a surface of the insert comprises a light reflective material.

19. The lighting arrangement of claim 9, further comprising a secondary reflector component with a first open end attached to the open end of the housing, wherein the secondary reflector component extends away from the housing.

20. The lighting arrangement of claim 9, wherein the wavelength conversion component comprises a hemispherical surface.
